(19) United States
(12) Patent Application Publication
(10) Pub. No.: US 2022/0346419 A1
(43) Pub. Date: Nov. 3, 2022

(54) MIXTURES COMPRISING RARE SUGARS AND TASTE MODIFYING COMPOUNDS

(71) Applicant: SYMRISE AG, Holzminden (DE)

(72) Inventors: Thomas RIESS, Holzminden (DE); Gerhard KRAMMER, Holzminden (DE); Jakob Peter LEY, Holzminden (DE); Katharina REICHELT, Holzminden (DE); Susanne PAETZ, Höxter (DE); Tom SOMERS, Holzminden (DE)

(21) Appl. No.: 17/435,751

(22) PCT Filed: Jan. 14, 2020
(86) PCT No.: PCT/EP2020/050770

§ 371 Date: Sep. 2, 2021

(30) Foreign Application Priority Data
Mar. 5, 2019 (EP) 19160796.9

(51) Int. Cl. A23L 27/30; A23L 2/60; A23L 2/56; A23L 27/00; A23L 27/60; A23L 2/39; A23G 1/56; A23C 9/13

(52) U.S. Cl. CPC A23L 27/34; A23L 2/60; A23L 2/56; A23L 27/88; A23L 27/63; A23L 2/39; A23G 1/56; A23C 9/1307; A23V 2002/00

(57) ABSTRACT

The present invention primarily relates to a mixture comprising or consisting of components a), b) and c), and optionally component d), wherein component a) is at least one rare sugar, component b) is at least one taste modifying compound, component c) is at least one natural sweet tasting compound, and component d) is at least one natural caloric sweet-tasting carbohydrate and/or at least one non-caloric sweet tasting sugar alcohol.

The present invention primarily relates to a mixture comprising or consisting of components a), b) and c), and optionally component d), wherein component a) is at least one rare sugar, component b) is at least one taste modifying compound, component c) is at least one natural sweet tasting compound, and component d) is at least one natural caloric sweet-tasting carbohydrate and/or at least one non-caloric sweet tasting sugar alcohol. A further aspect of the present invention relates to a flavoring composition, concentrate and/or intermediate for a food or beverage product comprising or consisting of a mixture according to the present invention. A flavoring composition, concentrate and/or intermediate for a food or beverage product comprising or consisting of a mixture according to the present invention is another aspect of the present invention. Yet another aspect pertains to a food or beverage product comprising a flavoring composition, concentrate and/or intermediate according to the present invention. Use of a mixture according to the invention, or use of a flavoring composition, a concentrate and/or an intermediate for a food or beverage product according to the invention imparting a sweet taste impression and/or reinforcing a sweet taste impression is a further aspect of the invention. A final aspect pertains to the use of a rare sugar for enhancing the onset sweetness intensity, overall sweetness intensity and/or full body of a mixture according to the present invention, or a flavoring composition, a concentrate, and/or an intermediate for a food or beverage product according to the present invention, and/or a food or beverage product according to the present invention. These and further aspects of the present invention as well as preferred embodiments thereof will emerge from the following description and accompanying claims.

Consumers generally have a strong preference for foodstuffs or indulgence foods which have a large amount of high caloric sugar, in particular sucrose (saccharose), glucose, fructose or mixtures thereof, due to the pleasant sweetness and sweetness profile associated therewith. On the other hand, it is generally known that a large content of readily metabolizable carbohydrates causes a steep rise in blood sugar levels, leads to the formation of fat deposits and ultimately can result in health problems such as overweight, obesity, insulin resistance, age-onset diabetes and complications thereof. Another particular aggravating factor is that many of the above-mentioned carbohydrates can also have an adverse effect on dental health, as they are decomposed by specific types of bacteria in the oral cavity into lactic acid, for example, and can attack the enamel of milk teeth or adult teeth (caries).

Therefore, it has long been an objective to reduce the high caloric sugar content of food or beverage products and replace it partly or entirely by other substances that impart a sweet taste.

Sweeteners are substances with no or of low energy value that provide sweet taste but do not have the calories of carbohydrates or their cariogenic or glycemic effects. Sweeteners have been used as substitutes for high caloric sugar in many sweet-tasting products. Sweeteners are reviewed, for example, in Journal of the American Dietetic Association 2004, 104 (2), 255-275.

Although so-called bulk sweeteners such as sorbitol, mannitol or other sugar alcohols are to some extent excellent sweeteners and can also replace to some extent the other foodstuff characteristics of high caloric sugars, when ingested too frequently by a proportion of the population they lead to osmotically conditioned digestion problems.

Due to their low application concentration, non-nutritive, high-intensity sweeteners are suitable for introducing sweetness into foodstuffs, however they often exhibit problems in respect of taste due to dissimilar time-intensity profiles (i.e. sweetness profiles) compared to high caloric sugars, in particular to sucrose, glucose, and fructose, (for example sucralose, steviosides, cyclamate), a bitter and/or astringent aftertaste (for example acesulfame-K, saccharin or its salts, steviosides, rebaudiosides) and/or pronounced additional flavor sensations such as “licorice” (for example glycyrrhizic acid ammonium salt). Some of the sweeteners are not particularly heat-stable (for example thaumatin, brazzein, monellin), are not stable in every application (for example aspartame) and some have a very long-lasting sweet effect (strong sweet aftertaste, for example saccharin, sucralose, rebaudiosides).

One possibility—without using non-nutritive sweeteners—is to reduce the high caloric sugar content of food or beverage products and to add substances which are sensorial faintly detectable or undetectable and which indirectly or directly enhance the sweetness, as described, for example in WO 2005/041684. However, the substances described in WO 2005/041684 are explicitly of a non-natural origin and thus, from a toxicological point of view, are more difficult to assess than substances of a natural origin, particularly if the latter occur in foodstuffs or indulgence foods or originate from raw materials for the production of food or beverage products. EP 1 291 342 describes such substances of a natural origin (pyridinium betaines); however, these substances do not influence the sweet taste selectively, but also influence other taste flavors such as umami or saltiness. Furthermore, the disclosed substances can only be purified with great effort.

A different approach to reduce the high caloric sugar content of food or beverage products is to replace a high caloric sugar by less caloric carbohydrates. As example, allulose (synonym to psicose) contains almost no calories content and yields less than about 5% of the calories of the equivalent amount of sucrose but exhibits about 70% of the sweetness intensity of sucrose. However, though allulose is a natural sugar and the taste and sweetness profile of allulose is very close to that of sucrose there are notable differences. The start of the sweetness of allulose is slower than of sucrose. Furthermore, it is possible that allulose imparts (mostly undesirable) off-tastes to food or beverage products, typically bitter, rindy, zesty, astringent, or an undesirable lingering sweetness. Moreover, the use of allulose as a replacement for high caloric sugar has some limitations due to cost and digestive tolerance in some applications at higher concentrations.

Another example is tagatose, which also yields only 38% calories compared to fructose and can be used as a sweetening agent (cf. WO 2004/073419). Nevertheless, the intrinsic sweetness of tagatose compared to sucrose is much lower and therefore it can practically not be used as a sole high caloric sugar replacer.

International patent application WO 2007/014879 to Symrise disclose another approach for reducing the sugar content. According to this approach, the sweet taste impression imparted by a sweet-tasting substance is enhanced by hesperetin so that the sugar content can be decreased. Among the sweet-tasting substances sucrose, trehalose and Stevia ssp. extracts are mentioned. Furthermore, a pudding is exemplified containing inter alia sucrose, 0.01% hesperetin and 0.1% D-tagatose. This pudding was compared with a like pudding, which contained 0.02% hesperetin instead of 0.01% hesperetin and 0.1% D-tagatose, and was found to have a comparable sweetness and an improved initial sweetness. However, the document is silent on whether, and if so how, D-tagatose contributed to the observed sweetness impression. Moreover, no mixture containing all of a rare sugar, a taste modifying compound, a natural sweet tasting compound and optionally a natural caloric sweet-tasting carbohydrate, e.g. hesperetin in combination with both trehalose and Stevia ssp. extracts and optionally sucrose, is disclosed.

The primary object of the present invention was to provide a mixture that is capable of reducing the amount of high caloric sugars and impart an improved sweetness impression. In particular, it was an aim to improve the sweet impact and mouthfeel and simultaneously reduce the sweet lingering profile and off-notes such as a bitter after-taste of the mixture or a product containing the mixture, while showing the same or a similar sweetness taste as mixtures or products with a high amount of high caloric sugars, in particular sucrose.

The primary object of the present invention is achieved by a mixture comprising or consisting of components a), b) and c), and optionally component d), wherein
component a) is at least one rare sugar,
component b) is at least one taste modifying compound selected from the group consisting of hydroxyflavonoids, dihydrochalcons, dihydroisocoumarins, hydroxylignans, and mixtures thereof,
component c) is at least one natural sweet tasting compound, and
component d), if present, is at least one natural caloric sweet tasting carbohydrate and/or at least one non-caloric sweet tasting sugar alcohol.

The term “rare sugar” is to be understood in its common meaning as denoting a sugar that occurs in nature in an amount that is commonly understood to be so small that it does not allow for an economic isolation. A rare sugar is therefore typically produced by fermentation or by enzymatic conversion from one or more compounds other than the rare sugar such as a precursor. As understood herein, a rare sugar as such (i.e. the compound alone) is further capable of imparting a sweet taste. That is, the rare sugar is preferably present in an amount (e.g., a concentration), in which the specified taste of the rare sugar as such would be perceptible. The rare sugar may be less sweet than sucrose, such as being at least 0.1 times, at least 0.2 times, at least 0.3 times or at least 0.4 times sweet as sucrose.

To reduce the calorie content of the mixture of the invention, preferred rare sugars have lower caloric values in humans than traditional sugars such as in particular sucrose, such as 0.9 times or less, more preferably 0.8 times or less, preferably 0.7 times or less, even more preferably 0.6 times or less and most preferably 0.5 times or less of sucrose’ caloric value in human. The caloric value of a compound such as a rare sugar in humans denote the energy (in calories) that a human being can draw from the compound when ingested. Usually, a sugar that is resorbed well and metabolized easily into glucose provides much energy as the glucose can be further metabolized and used for energy production in the citrate cycle. If resorption and/or metabolization is low but the sweetness impression is good, a sweet sensation can be provided without providing much energy to the body.

In other terms, the caloric value, as understood herein, refers to the specific (total) physiological caloric value, which is defined as the caloric value of a sugar (or other carbohydrate) which is released during metabolism of the respective sugar in a (human) body. For exemplary sugars, respective values have been deduced from the literature and summarized in the following table.

| | Specific |
|---|---|
| | physiological |
| | caloric value |
| | kcal/g |
| glucose, fructose, lactose, high | 4.0 |
| fructose corn sirup (HFCS) | |
| D-(−)-tagatose | 1.5 |
| D-(+)-trehalose | 3.6 |
| D-(+)-xylose | 1.0-1.4 |
| D-(+)-allulose | 0.2 |

As used herein, a “natural sweet tasting compound” is a naturally occurring compound, which as such is capable of imparting a sweet taste. Preferred natural sweet tasting substances are sweeter than sucrose such as being at least 5 times, preferably at least 10 times, more preferably at least 50 times, most preferably at least 100 times sweeter than sucrose based on weight and a sweetness of 2% sucrose level. The natural sweet tasting compound may be a non-saccharide compound. Moreover, the natural sweet tasting compound is preferably present in an amount (e.g., a concentration), in which the specified taste of the natural sweet tasting compound as such would be perceptible.

To test whether a mixture contains the natural sweet tasting compound in an amount in which the sweet taste of the natural sweet tasting compound as such is perceptible, the concentration of the natural sweet tasting compound contained in the mixture of interest could be determined and the natural sweet tasting compound could be added to a like mixture that does not contain any further compound that could impart a sweet taste; in case of a solution, a blank solution of water may be used. A corresponding methodology may be applied for other compounds that are specified to be sweet tasting such as the natural caloric sweet tasting carbohydrate.

The term “natural caloric sweet tasting carbohydrate” denotes a naturally occurring carbohydrate that is capable of imparting a sweet taste. The natural caloric sweet tasting carbohydrate, if present, is preferably present in an amount (e.g., a concentration) in which the specified taste of the natural caloric sweet tasting carbohydrate as such would be perceptible. The term caloric means the specific total physiological caloric value of certain carbohydrates which will be released during metabolism of the respective carbohydrate in the (human) body. In certain embodiment, the natural caloric sweet tasting carbohydrate(s) has/have a specific total physiological caloric value (in kcal/g) of 1.0, or higher, 1.5, or higher, 2.0, or higher, 2.25 or higher, 2.50 or higher, 2.75, or higher, 3.00, or higher, 3.25, or higher, 3.50, or higher, 3.75, or higher, or 4.0, or higher.

The term “non-caloric sweet tasting sugar alcohol” denotes a reduced carbohydrate which can be derived from nature or prepared by synthetic or fermentative/biotechnological approaches; preferred as “non-caloric sweet tasting sugar alcohol” are sorbitol, xylitol, isomalt, lactitol, maltitsorbitol, erythritol, mannitol, galactitol,

It was surprisingly found that a mixture comprising component a), component b) and component c), as defined herein, is associated with a remarkable improved sweetness profile over like mixtures that lack one of the components. In particular, a remarkably increased onset sweetness intensity, overall sweetness intensity and mouth feeling (full body) could be achieved. The beneficial effect was particularly pronounced with respect to the full body effect. Furthermore, the mixture comprising component a), component b) and component c) has also the advantage that it provides a beneficial base for a four-component mixture further component d), which achieves an even enhanced beneficial effect with respect to the sweetness profile including an emphasis of the desired effects and a suppression of the undesired effects. Hence, a superior sweetness taste profile is associated with the mixture of the present invention.

For the purposes of the present invention, the component a) is preferably selected from the group consisting of D-(+)-allulose, L-(+)-rhamnose, L-(−)-fucose, L-(+)-arabinose, D-(−)-tagatose, D-(+)-trehalose, D-(+)-xylose, D-(+)-allose, D-(+)-altrose, D-(−)-gulose, D-(+)-mannose, D-(−)-idose, D-(+)-talose, D-(−)-lyxose, (D)-xylulose, (D)-ribulose, D-(−)-erythrose, D-(−)-threose, D-(+)-melezitiose, D-(+)-raffinose and mixtures thereof. Preferably, the component a) is selected from the group consisting of D-(+)-allulose, L-(+)-rhamnose, L-(+)-arabinose, D-(−)-tagatose, D-(+)-trehalose, D-(+)-allose and mixtures thereof.

The component c) is preferably selected from the group consisting of steviol glycosides, steviolmonosides, steviolbioside A, steviolbioside B, stevioside B, stevioside C, rebaudioside A, rebaudioside AM, rebaudioside B, rebaudioside C (dulcoside B), rebaudioside D, rebaudioside E, rebaudioside E2, rebaudioside E3, rebaudioside F, rebaudioside I, rebaudioside H, rebaudioside L, rebaudioside K, rebaudioside KA, rebaudioside J, rebaudioside N, rebaudioside O, rebaudioside M, rebaudioside X, dulcoside A, rubusoside, glycosylated rubusosides, suavososides, Rubus suavissumus leaf extract, Stevia leaf extract, stevioside, glycosylated steviol glycosides, glycosylated steviosides, mogroside V, isomogroside, mogroside IV, Luo Han Guo fruit extract, siamenoside, monatin and its salts (monatin SS, RR, RS, SR), curculin, glycyrrhizic acid and its salts, thaumatin, monellin, mabinlin, brazzein, hernandulcin, Lippia dulcis extract, glycyphyllin, Smilax glycyphylla extract, phloridzin, Malus derived extracts, trilobatin, Malus trilobata derived extraxts, baiyunoside, osladin, polypodoside A, pterocaryoside A, pterocaryoside B, mukurozioside, phlomisoside I, periandrin I, abrusoside A, cyclocarioside I, Balansin A, Balansin B, and combinations thereof.

Alternatively, the component c) can be selected from the group consisting of steviolmonoside, steviolmonoside A, steviolbioside, steviolbioside D, rubusoside, steviolbioside A, steviolbioside B, rebaudioside B, stevioside, rebaudioside G, stevioside A, stevioside B, stevioside C, rebaudioside A, rebaudioside E, rebaudioside E2, rebaudioside E4, rebaudioside E6, rebaudioside E3, rebaudioside D, rebaudioside /, rebaudioside AM, rebaudioside D7, rebaudioside M, rebaudioside M4, rebaudioside Ia, rebaudioside Ib, rebaudioside Ic, rebaudioside Id, rebaudioside Ie, rebaudioside If, rebaudioside Ig, rebaudioside Ih, rebaudioside Ii, rebaudioside Ij, rebaudioside Ik, rebaudioside 11, rebaudioside Im, rebaudioside In, rebaudioside Io, rebaudioside Ip, rebaudioside Iq, rebaudioside Ir, rebaudioside Is, rebaudioside It, rebaudioside 2a, rebaudioside 2b, rebaudioside 2c, rebaudioside 2d, rebaudioside 2e, rebaudioside 2f rebaudioside 2g, rebaudioside 2h, rebaudioside 2i, rebaudioside 2j, rebaudioside 2k, rebaudioside 21, rebaudioside 2m, rebaudioside 2n, rebaudioside 2o, rebaudioside 2p, rebaudioside 2q, rebaudioside 2r, rebaudioside 2s, SvG7, and combinations thereof.

A mixture according to the present invention is preferred, wherein component b) comprises or consists of hesperetin, hesperetin dihydrochalcone, naringenin, phloretin, eriodictyol, homoeriodictyol, and mixtures thereof. More preferably, component b) comprises or consists of:
hesperetin or hesperetin dihydrochalcone or phloretin or phyllodulcin, or
hesperetin and hesperetin dihydrochalcone, or
hesperetin and phloretin, or
hesperetin and phyllodulcin, or
hesperetin dihydrochalcone and phloretin, or
hesperetin dihydrochalcone and phyllodulcin, or
phloretin and phyllodulcin,
hesperetin and hesperetin dihydrochalcone and phloretin, or
hesperetin and hesperetin dihydrochalcone and phyllodulcin, or
hesperetin and phloretin and phyllodulcin, or
hesperetin dihydrochalcone and phloretin and phyllodulcin, or
hesperetin and hesperetin dihydrochalcone and phloretin and phyllodulcin.

Hesperetin including its enantiomers and salts and their mixtures as used in mixtures according to the present invention are known to the person skilled in the art and are for example described in the European patent EP 1 909 599 B1.

Hesperetindihydrochalcone including salts and their mixtures as used in mixtures according to the present invention are known to the person skilled in the art and are for example described in the patent application WO 2017/186299.

Phloretin including salts and their mixtures as used in mixtures according to the present invention are known to the person skilled in the art and are for example described in the European patent EP 1 998 636 B1.

Eriodictyol, homoeriodictyol including their enantiomers and salts and their mixtures as used in mixtures according to the present invention are known to the person skilled in the art and are for example described in the European patent EP 1 258 200 B1.

Phyllodulcin including its enantiomers and salts and their mixtures as used in mixtures according to the present invention are known to the person skilled in the art and are for example described in the European patent EP 2 298 084 B1.

A mixture according to the present invention is preferred, wherein component c) comprises or consists of at least one steviol glycoside, preferably rebaudioside A, glucosylated steviosides, rubusoside, glycosylated rubusoside, stevia leaf extract, Rubus suavissimus extract, mogrosides, luo han guo or mixtures thereof.

Rebaudioside A (herein also referred to as Reb A) is a steviol glycoside that is 200 times sweeter than sugar.

Steviol glycoside or steviosides are glycosides of steviol that can be found in leaves of Stevia rebaudiana, Stevia phlebophylla and Rubus chingii.

Rubusosides occur in Chinese sweet tea plant (Rubus suavissimus) and are closely related to glucosides found in Stevia rebaudiana. Glycosylated rubusosides such as alpha-glycosyl rubusosides are known to the person skilled in the art and are for example described in the patent application WO 2015/189346 (A1).

Mogrosides are glycosides of cucurbitane derivatives found in certain plants, such as the fruit of the gourd vine, luo han guo.

A mixture according to the present invention is preferred, wherein component d), if present, comprises or consists of at least one sugar selected from the group consisting of sucrose, fructose, glucose, galactose, lactose, dextrose, maltose and mixtures thereof, preferably sucrose, D-fructose, D-glucose, D-galactose, D-lactose, D-maltose and mixtures thereof.

Specific mixtures according to the present invention are obtained by permutation of each compound disclosed herein for component a) with each compound disclosed herein for component b) and each compound disclosed herein for component c) and, optionally, each compound disclosed herein for component d).

Preferred specific mixtures according to the present invention are obtained by permutation of each of D-(+)-allulose, L-(+)-rhamnose, L-(+)-arabinose, D-(−)-tagatose, D-(+)-trehalose, D-(+)-allose as component a) with each of hesperetin, hesperetin dihydrochalcone, naringenin, phloretin, eriodictyol, homoeriodictyol, and mixtures thereof (in particular the mixtures recited in claim 3) as component b) and each of a steviol glycoside, preferably rebaudioside A, a glucosylated stevioside, rubusoside, glycosylated rubusoside, Stevia leaf extract, Rubus suavissimus extract, mogrosides and luo han guo as component c), and, optionally, each of D-(+)-glucose (dextrose), D-(−)-fructose, D-sucrose, D-galactose, D-lactose and D-maltose as component d).

A mixture according to the present invention is preferred, wherein the weight ratio of component a) to component b) ranges from 100,000:1 to 10:1, preferably from 20,000:1 to 100:1 and more preferably from 10,000:1 to 500:1.

Preferred is also a mixture according to the present invention, wherein the weight ratio of component a) to component c) ranges from 20,000:1 to 2:1, preferably from 5,000:1 to 20:1 and more preferably from 2,000:1 to 50:1.

A mixture according to the present invention is preferred, wherein the weight ratio of component a) to component d), if present, ranges from 10:1 to 1:200, preferably from 10:1 to 1:20 and more preferably from 5:1 to 1:10.

Preferred is also a mixture according to the present invention, wherein the weight ratio of component b) to component c) ranges from 100:1 to 1:100, preferably from 10:1 to 1:40 and more preferably from 2:1 to 1:15.

A mixture according to the present invention is preferred, further comprising component e), wherein component e) is at least one substance selected from the group consisting of flavorings and/or aromatic substances other than compounds defined by (i.e. falling within the definition of) components a) to d).

In the context of the present invention, the component e) preferably comprises or consists of at least one substance selected from the following group:

aliphatic flavouring substances, especially saturated aliphatic alcohols, such as ethanol, isopronanol, butanol, isoamyl alcohol, hexanol, 2-heptanol, octanol (1/2/3), decanol, unsaturated aliphatic alcohols, such as cis-2 pentenol, cis-3 hexenol, trans-2 hexenol, trans-3 hexenol, cis-2 octenol, 1-octen-3-ol, cis-6 nonen-1-01, trans-2, cis-6 nonadienol, aliphatic aldehydes such as saturated aliphatic aldehydes (e.g. acetaldehyde, propionaldehyde, butyraldehyde, isobutyraldehyde, valeraldehyde, isolvaleraldehyde, hexanal, 3-methyl hexanal, octanal, nonanal, or mono- or multi-unsaturated aliphatic aldehydes, such as 2-methyl but-2-enal, trans-2 hexenal, cis-3 hexenal, cis-4 hexenal, trans-2 octenal, trans-2 nonenal, cis-6 nonenal, trans-2, cis-6 nonadienal, trans 2 decenal, trans-2, trans-decadienal, aliphatic ketones, e.g. saturated ketones (such as 2-butanone, 2-pentanone, 2-heptanone, 2-octanone, 2-methylheptan-3-one, 2-decanone, 2-undecanone), unsaturated ketones (such as 1-penten-3-one, 1-hexen-3-one, 5-methyl-3-hexenone, 3-hepten-2-one, 1-octen-3-one, 2-octen-4-one, 3-octen-2-one, 3-none-2-one), aliphatic diketones and aliphatic diketoles, e.g. diacetyl, acetyl methyl carbinol, 2,3-hexanedione, aliphatic acids, such as straight-chain saturated acids, such as acetic acid, propionic acid, butyric acid, isobutyric acid, valeric acid, heptanoic acid, octanoic acid, decanoic acid, branched-chain saturated acids, such as 2-methyl heptanoic acid, 4-ethyl octanoic acid, and unsaturated acids, such as 2-butenoic acid, 2-pentenoic acid, 4-pentenoic acid, 2-methyl pentenoic acid, trans-3 hexenoic acid, cis-3 hexenoic acid, 3-octenoic acid, linoleic acid), aliphatic esters, such as saturated esters, e.g. methyl acetate, methylbutyrate, methyl-2-methylbutyrate, methyl hexanoate, ethylacetate, ethylbutyrate, ethyl-2-methylbutyrate, ethyl-3-methylbutyrate, ethyl hexanoate, ethyl decanoate, isopropyl acetate, isobutyl acetate, isobutyl valerate, isoamyl acetate, isoamyl butyrate, isoamyl isovalerate, hexyl acetate, hexyl hexanoate, 3-octyl acetate and unsaturated esters, such as methyl 2-hexenoate, allyl hexanoate, cis-3 hexenyl acetate, cis-3 hexenyl butyrate, aliphatic thiols and dithiols (e.g. propane thiol, allyl mercaptan, 1-methoxy-3-methylbutane-3-thiol, dimethyl sulfide, dimethyl trisulfide, dipropyl sulfide, diallyl trisulfide, other aliphatic sulfur compounds, such as 2-mercapto-3-butanol, methyl thio propanal, 3-mercapto-pentanone, 4-methoxy-2-methyl-2-mercaptobutanone, methyl thiobutyrate, methyl thiobutyrate, methyl 3-methylthiopropionate, aliphatic nitrogen compounds, such as butyl amine, trimethyl amine, allyl isothiocyanate, isopropyl isothiocyanate, alicyclic compounds, such as alicyclic ketones, e.g. cis-jasmone, isophorone, 4-ketoisophorone, alicyclic esters such as methyl jasmonate, hedione, terpenes, e.g. terpene alcohols, such as linalool, citronellol, geraniol, nerol, alpha terpineol, menthol, 8-p-menthene-1,2-diol, fenchol, borneol, nerolidol, hotrienol, terpene aldehydes such as geranial, neral, citronellal, beta-sinensal, terpene ketones, such as alpha-ionone, (D)-carvone, (L)-carvone, nootkatone, piperitone, menthone, alpha damascone, beta damascene, damascenone, terpene esters, such as linalyl acetate, geranyl acetate, citronellyl actetate, carvyl acetate, fenchyl acetate, terpene sulphur compounds, 4-mentha-8-thiol-3-one, thiogeraniol, para-menth-1-ene-8-thiol, mercapto p-menthan-3-one, terpene hydrocarbons, such as D-limonene, L-limonene, alpha-pinene, beta-pinene, ocimene, alpha-terpinene, gamma-terpinene, beta-bisabolene, valencene, terpene oxides, such as 1,8-cineole, rose oxide, mint lactone, menthofuran, aromatic compounds, e.g. aromatic alcohols, such as benzyl alcohol, cinnamyl alcohol, 2-phenyl alcohol, aromatic aldehydes, such as benzaldehyde, cinnamic aldehyde, 5-methyl-2-phenylhexenal, salicylaldehyde, 4-hydroxy benzaldehyde, cyclamen aldehyde, 2-phenyl-2-butenal, aromatic acids, such as 2-phenyl acetic acid, cinnamic acid, aromatic esters such as benzyl acetate, benzyl salicylate, anisyl acetate, methyl phenyl acetate, methyl benzoate, methyl salicylate, methyl cinnamate, aromatic phenols, such as phenol, ortho-cresol, para-cresol, 2,3-dimethyl phenyl, 2-ethyl phenol, 2,3,5-trimethyl phenol, 4-vinyl phenol, guaiacol, 4-vinyl guaiacol, eugenol, thymol, carvacrol, aromatic sulphur compounds, such as thiophenol, diphenyl disulphide, aromatic nitrogen compounds, such as methyl anthranilate, methyl N-methyl anthranilate, aromatic ethers such as vanillin, ethylvanillin, anethol, aromatic oxides, such as heliotropine, diphenyl oxide, aromatic lactones, such as coumarin, dihydro coumarin, heterocyclic compounds, such as heterocyclic lactones, e.g. gamma butyrolactone, gamma-nonalactone, gamma decalactone, delta decalactone, jasmin lactone, delta dodecalactone, ambrettolide, heterocyclic furanes, such as furfuryl alcohol, furfural, 2-acetyl furan, theaspirane, 2-methyl tetrahydrofuran-3-one, furfuryl mercaptane, 2-methyl 3-furanthiol, 2-methyl 3-tetrahydro furanthiol, difurfuryl sulfide, difurfuryl disulfide, heterocyclic pyrans, such as maltol, ethyl maltole, rose oxide, maltol isobutyrate, heterocyclic pyrroles such as indole, 2-acetyle pyrrole, pyrrolidine, heterocyclic pyrazines, such as 2-methyl pyrazine, 2,3-dimethyl pyrazine, 2-methyl 3-ethyl pyrazine, trimethyl pyrazine, 2-acetyl pyrazine, 2-methoxy 3-methyl pyrazine, 2-methoxy 3-ethyl pyrazine, 2-methoxy 3-isobutyl pyrazine, 2-ethyl 3-methylthio pyrazine, heterocyclic thiazoles, such as thiazole, 2-methyl thiazole, 4-methyl 5-vinyl thiazole, 2-isobutyl thiazole, 2-acetyl thiazole,

flavouring raw materials and flavouring preparations, e.g. essential oils, concretes, absolutes, extract or tinctures from raw materials such citrus (e.g. lemon, lime, mandarine, bergamotte, grapefruit bitter orange, peel or essence oils), herbs (dill, parsley, cumin, rosemary, sage, clary sage, basil, tarragon, thyme, oregano, savoury, majoram, all spice, mace, nutmeg, clove leave, clove bud, caraway, cinnamom leaves, cinnamom bark, cassia, cardamom, ginger, galangal, turmeric, coriander seed, coriander leaf, fenugreek, juniper berry, wormwood, laurel leaves, eucalyptus, white pepper, green pepper, white pepper, carrot seed, celery seed, lovage leaf, asa foetida, onion, leek, garlic, mustard, horse radish, capsicum, paprika, sea weed, valerian oil, fir needle, spearmint, peppermint, wintergreen, buchu leaf, black currant buds, fennel, star anise, jambu, long pepper, davana, orris, mimosa, cassie, violet leaves, ho leaf, jasmin, ylang ylang, cananga, osmanthus, angelica, clary sage, ambrette seed, hops, camomile, lavender, rose, geranium, citronella, palmarosa, litsea cubeba, lemon grass, tagetes, neroli, petitgrain, mate, cognac oil, coffee, cola nut, cocoa, green tea, black tea, white tea, gentian, tolu balm, benzoe resin, peru balm, cascarilla, galbanum, vetiver, labdanum, patchouli, sandalwood, cedarwood, guaiac wood, oak wood, massoi bark, vanilla pods, tonka bean, as well as enriched fractions thereof,

juice concentrates, such as orange juice, lemon juice, strawberry, cherry juice, or passion fruit juice concentrates, waterphases and recoveries from raw materials such as citrus (lemon, lime, orange, mandarine, grapefruit), apple, pear, quince, mispel, red fruits (raspberry, strawberry, blueberry, blackberry, Amellanchia (June plum), rose hip, cranberry, plum, prune, red and black currant, etc.) yellow fruits (peach, apricot, nectarine, banana, etc.), tropical fruits (mango, passionfruit, pineapple, lychee, etc.), vegetables (e.g. cucumber, tomato) and spices (e.g. ginger),

acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethylisobutyrate, ethylisovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzyl acetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenol acid, methylthiobutyrate, 3,1-methylthiohexanol, 3-methylthiohexyl acetate, nerol, nerol acetate, trans,trans-2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-s thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3 (2H)-furanone and derivatives thereof (here preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethyl maltol), coumarin and coumarin derivatives, gamma-lactones (here preferably gamma-undecalactone, gamma-nonalactone, gam ma-decalactone), delta-lactones (here preferably 4-methyldeltadecalactone, massoilactone, deltadecalactone, tuberolactone), methyl sorbate, divanillin, 4-hydroxy-2(or 5)-ethyl-5 (or 2)-methyl-3 (2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulphide, furfurylmercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-di methylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2(5H)-furanone, 3-hydroxy-4-methyl-5-ethyl-2(5H)-furanone, cinnamaldehyde, cinnamon alcohol, methyl salicylate, isopulegol and (here not explicitly stated) stereoisomers, enantiomers, positional isomers, diastereomers, cis/trans isomers or epimers of these substances.

In some embodiments, the mixture is free or substantially free of tannins or tannoids.

Should a substance from the above groups fall in one of the groups of components a) to d), then the substance shall per definition belong to the group of component e) and not to any one of the groups of components a) to d).

In one embodiment, a mixture according to the invention is liquid, for example a syrup. In another embodiment, a mixture according to the invention is solid, e.g. spray dried. A mixture according to the present invention may contain one or more carriers, wherein said carriers can be solid or liquid (at 25° C. and 1013 mbar). As carriers, either individual substances or substance mixtures can be used.

Advantageous solid carriers in preferred (preferably spray dried) mixtures according to the invention are silicon dioxide (silicic acid, silica gel), carbohydrates (other than sugars) and/or carbohydrate polymers (polysaccharides), cyclodextrins, flours, e.g. rice flour (according to WO 2018/219465), starches, degraded starches (hydrolyzed starches), chemically or physically modified starches, modified cellulose, gum arabic, gum ghatti, tragacanth, gum karaya, carrageenan, guar germ meal, locust bean gum, alginates, pectin, inulin or xanthan gum. Preferred hydrolyzed starch products are maltodextrins and dextrins.

Preferred solid carriers are silicon dioxide, flours, gum arabic and maltodextrins, wherein maltodextrins with DE values in the range of 5 to 20 are preferred. It is unimportant which plant originally provided the starch for producing the starch hydrolysates. The degree of decomposition of the starch is usually denoted with the characteristic value “Dextrose Equivalent” (DE) which can vary between the limit values 0 for a long-chain glucose polymer and 100 for pure glucose. Maize-based starches are suitable and readily available, as are starches from tapioca, rice, wheat or potatoes. The carriers can also simultaneously serve as anticaking agents, as in the case of silicon dioxide. These carriers have the advantage that they are completely or substantially taste-free. In this way, addition of the carriers do not influence the existing sensory profile, particularly the aroma and taste profile, imparted by the components a) to c) and optionally d) and/or e) of the mixture according to the invention.

Preferred liquid carriers are water, ethanol, isopropanol, glycerin, 1,2-propylene glycol, 1,3-propandiol, diacetin, triacetin and mixtures thereof. Other suitable liquid carriers can also be based on artificially or naturally derived sirups from different native carbohydrates and/or (partially) hydrolyzed starch, e.g. high fructose corn sirup, honey, agave sirup, high fructose apple sirup, high fructose pear sirup, native or hydrolysed sugar beet sirup, maple sirup, date sirup. Further suitable carriers are triglycerides, preferably liquid triglycerides, for example, plant oils. Preferable are triglycerides with the same or different C6 to C10-fatty acid groups (MCT, medium-chain triglycerides), since these are also essentially taste-free.

A mixture according to the present invention may be used in a food or beverage product to replace a part of the high caloric sugar content of a like food or beverage product. In this case, a mixture according to the present invention free of component d) may serve as a kind of diluent for a food or beverage product in which the high caloric sugar content is to be reduced. A mixture according to the present invention may also be used as a flavoring composition, concentrate and/or intermediate, which already contains all sweetness imparting components and preferably also all or most flavor imparting components. In this case, a mixture according to the present invention may include component d) and/or component e), and may be filled up with water or milk or the like to give the final food or beverage product.

Accordingly, a further aspect of the present invention relates to a flavoring composition, concentrate and/or intermediate for a food or beverage product comprising or consisting of a mixture according to the present invention. Another aspect pertains to a food or beverage product comprising a flavoring composition, concentrate and/or intermediate according to the present invention, or a mixture according to the present invention.

Food or beverage products in the context of the present invention are, for example, baked products (e.g. bread, biscuits, cakes, other baked goods), confectionery (e.g. chocolates, chocolate bar products, other bar products, fruit gums, hard and soft toffees, chewing gum), alcoholic or non-alcoholic beverages (e.g. coffee, tea, wine, wine-containing beverages, beer, beer-containing beverages, liqueurs, spirits, brandies, fruit-containing lemonades, isotonic beverages, refreshing beverages, nectars, fruit and vegetable juices, fruit or vegetable juice preparations), instant beverages (e.g. instant-cocoa beverages, instant-tea beverages, instant-coffee beverages), meat products (e.g. ham, processed sausage or raw sausage preparations, spiced or marinated fresh or cured meat products), eggs or egg products (dried egg, egg white, egg yolk), cereal products (e.g. breakfast cereals, muesli bars, precooked prepared rice products), milk products (e.g. milk beverages, milk ices, yoghurt, kefir, fresh cheese, soft cheese, hard cheese, dried milk powder, whey, butter, buttermilk, partially or fully hydrolyzed lactoprotein-containing products), products from soybean protein or other soybean fractions (e.g. soybean milk and products prepared therefrom, preparations containing soybean lecithin, fermented products such as tofu or tempeh or products prepared therefrom, soy sauces), fruit preparations (e.g. jellies, fruit ices, fruit sauces, fruit fillings), vegetable preparations (e.g. ketchup, sauces, dried vegetables, frozen vegetables, precooked vegetables, vegetables pickled in vinegar, preserved vegetables), nibbles (e.g. baked or fried potato chips or potato dough products, bread dough products, extruded products based on maize or peanuts), fat-based and oil-based products or emulsions thereof (e.g. mayonnaise, remoulade, dressings, seasoning preparations), other ready-meals and soups (e.g. dried soups, instant soups, precooked soups), spices, seasoning mixtures and in particular seasonings which are used, for example, in the making of snacks.

In particular in cases, where in regular food or beverage products high caloric sugars are used as bulk materials, texturizers, fillers and stabilizers, namely baked products (e.g. bread, biscuits, cakes, other baked goods), confectionery (e.g. chocolates, chocolate bar products, other bar products, fruit gums, hard and soft toffees, chewing gum), cereal products (e.g. breakfast cereals, muesli bars, precooked prepared rice products), fruit preparations (e.g. jellies, fruit ices, fruit sauces, fruit fillings), vegetable preparations (e.g. ketchup, sauces, dried vegetables, frozen vegetables, precooked vegetables, vegetables pickled in vinegar, preserved vegetables), the amount of high caloric sugars can be partly replaced by the mixtures according to the present invention. In a preferred embodiment of these food or beverage products, further technologies to replace high caloric sugar load can be achieved in combinations of a mixture according to the present invention with technologies according to the PCT application with application number PCT/EP2018/069323.

The food or beverage products within the meaning of the invention can also be present as dietary supplements in the form of capsules, tablets (uncoated and coated tablets, e.g. gastro-resistant coatings), sugar-coated pills, granulates, pellets, solid mixtures, dispersions in liquid phases, as emulsions, as powders, as solutions, as pastes or as other formulations that can be swallowed or chewed.

Chewing gums (as a further example of food or beverage products) generally comprise a chewing gum base, i.e. a chewing mass that becomes plastic when chewed, other taste correctives for unpleasant taste impressions, taste modulators for further, generally not unpleasant taste impressions, taste-modulating substances (e.g. inositol phosphate, nucleotides such as guanosine monophosphate, adenosine monophosphate or other substances such as sodium glutamate or 2-phenoxypropionic acid), humectants, thickeners, emulsifiers, further flavors and stabilizers or odor correctives.

A food or beverage product according to the invention is preferred, wherein the amount of the mixture of the invention ranges from 0.05 to 25% by weight, preferably from 0.1 to 20% by weight, more preferably from 0.5 to 15.0% by weight, based on the total weight of the food or beverage product.

Preferred is further a food or beverage product according to the invention, wherein the amount of component a) ranges from 0.1 to 10% by weight, preferably from 0.2 to 8% by weight, more preferably from 0.5 to 5.0% by weight, based on the total weight of the food or beverage product.

A food or beverage product according to the invention is further preferred, wherein the amount of component b) ranges from 1 to 100 ppm by weight, preferably from 2 to 90 ppm by weight, more preferably from 4 to 80 ppm by weight, based on the total weight of the food or beverage product.

Preferred is further a food or beverage product according to the invention, wherein the amount of component c) ranges from 5 to 500 ppm by weight, preferably from 10 to 200 ppm by weight, more preferably from 20 to 100 ppm by weight, based on the total weight of the food or beverage product.

A food or beverage product according to the invention is further preferred, wherein the amount of component d), if present, ranges from 1.0 to 30% by weight, preferably from 1.5 to 15% by weight, more preferably from 1.5 to 10% by weight, even more preferably from 1.5 to 5% by weight and most preferably from 1.5 to 4% by weight, based on the total weight of the food or beverage product.

Specific food or beverage products according to the present invention comprise or consist of the specific mixtures according to the present invention obtained by permutation of each compound disclosed herein for component a) with each compound disclosed herein for component b) and each compound disclosed herein for component c) and, optionally, each compound disclosed herein for component d).

Preferred specific food or beverage products according to the present invention comprise or consist of the preferred specific mixtures according to the present invention obtained by permutation of each of D-(+)-allulose, L-(+)-rhamnose, L-(+)-arabinose, D-(−)-tagatose, D-(+)-trehalose, D-(+)-allose as component a) with each of hesperetin, hesperetin dihydrochalcone, naringenin, phloretin, eriodictyol, homoeriodictyol, and mixtures thereof (in particular the mixtures recited in claim 3) as component b) and each of a steviol glycoside, preferably rebaudioside A, a glucosylated stevioside, rubusoside, glycosylated rubusoside, stevia leaf extract, Rubus suavissimus extract, mogrosides and luo han guo as component c), and, optionally, each of D-(+)-glucose (dextrose), D-(−)-fructose, D-sucrose, D-galactose, D-lactose and D-maltose as component d).

Particularly preferred is a food or beverage product wherein
component a) comprises or consists of L-arabinose, D-tagatose, D-allulose, D-allose, L-rhamnose, D-trehalose or combinations thereof,
component b) comprises or consists of phloretin, hesperetin or combinations thereof,
component c) comprises or consists of rebaudioside A, glycosylated rubusoside, glucosylated steviosides, luo han guo extract or combinations thereof,
   and optionally
component d) comprises or consists of sucrose, glucose, fructose, lactose or combinations thereof.

A food or beverage product according to the invention is preferred, further comprising component f), wherein component f) is at least one artificial sweet tasting compound (e.g. a high intensity sweetener). The at least one artificial sweet tasting compound is preferably selected from the group consisting of sucralose, acesulfame potassium or other salts, aspartame, alitame, sodium or calcium salt of saccharin, neohesperidin dihydrochalcone, sodium cyclamate, neotame, superaspartame, advantame, thaumatin, and salts thereof.

As further constituents for a food or beverage product according to the present invention, a flavoring composition, concentrate and/or intermediate according to the present invention or for a mixture according to the present invention, it is possible to use usual base materials, auxiliaries and additives for foodstuffs and semiluxury food products, for example, water, mixtures of fresh or processed plant or animal basic or raw materials (e.g. raw, roasted, dried, fermented, smoked and/or boiled meat, bone, cartilage, fish, vegetables, fruit, herbs, nuts, vegetable or fruit juices or pastes or mixtures thereof), natural or hardened fats (e.g. tallow, lard, palm oil, coconut oil, hardened plant fat), oils (e.g. sunflower oil, peanut oil, corn oil, olive oil, fish oil, soybean oil, sesame oil), fatty acids or salts thereof (e.g. potassium stearate), proteinogenic or nonproteinogenic amino acids and related compounds (e.g. γ-aminobutyric acid, taurine), peptides (e.g. glutathione), native or processed proteins (e.g. gelatin), enzymes (e.g. peptidases), nucleic acids, nucleotides, other flavor correctants for unpleasant taste impressions, taste modulators for further, as a rule not unpleasant, taste impressions, flavour-modulating substances (e.g. inositol phosphate, nucleotides such as guanosine monophosphate, adenosine monophosphate or other substances such as sodium glutamate or 2-phenoxypropionic acid), emulsifiers (e.g. lecithins, diacylglycerols, gum arabic), stabilizers (e.g. carrageenan, alginate), preservatives (e.g. benzoic acid, sorbic acid), antioxidants (e.g. tocopherol, ascorbic acid), chelating agents (e.g. citric acid), organic or inorganic acidifying agents (e.g. malic acid, acetic acid, citric acid, tartaric acid, phosphoric acid), bitter substances (e.g. quinine, caffeine, limonin, amarogentin, humolones, lupolones, catechins, tannins), mineral salts (e.g. sodium chloride, potassium chloride, magnesium chloride, sodium phosphates), substances preventing enzymatic browning (e.g. sulphite, ascorbic acid), essential oils, plant extracts, natural or synthetic dyes or colored pigments (e.g. carotenoids, flavonoids, anthocyans, chlorophyll and derivatives thereof), spices, trigeminally effective substances or plant extracts containing said trigeminally effective substances, synthetic, natural or nature-identical aromatic substances or odoriferous substances and odor correctants.

A further aspect of the present invention relates to the use of a mixture according to the present invention, or a flavoring composition, a concentrate and/or an intermediate according to the present invention for imparting a sweet taste impression and/or reinforcing a sweet taste impression (on a food or beverage product).

A yet further aspect of the present invention relates to the use of a rare sugar for enhancing the onset sweetness intensity, overall sweetness intensity and/or full body of a mixture according to the invention, or a flavoring composition, a concentrate, and/or an intermediate according to the invention, and/or a food or beverage product according to the invention.

Further advantages will be apparent upon reading the following examples.

### EXAMPLES

Unless otherwise stated, percentages given herein refer to weight percentages per weight, i.e. % (w/w). The term “x° Brix” denotes a mixture comprising x % sucrose; that is, 2°Brix means a mixture comprising 2% sucrose and 5°Brix means a mixture comprising 5% sucrose.

Further, in the column headers below, the following abbreviations are used. The phrase “onset intensity” is short for onset sweetness intensity <2 sec. The phrase “overall intensity” is short for overall sweetness intensity. The phrase “lingering artificial” is short for “lingering artificial sweetness”. The phrase “off-notes” is short for off-notes (bitter, metallic, astringent).

Moreover, the following abbreviations are referred to in the following:

allulose D-(+)-allulose,

arabinose L-(+)-arabinose,

rhamnose L-(+)-rhamnose,

tagatose D-(−)-tagatose,

trehalose D-(+)-trehalose

HC hesperetin dihydrochalkon,

HT hespertin,

PH phloretin,

SG steviol glycoside,

OR glycosylated rubusoside,

LHG Lo Han Guo

### Example 1: Sweetness-Enhancing Effect Imparted by a Rare Sugar in a Mixture Further Comprising a Natural Sweet Tasting Compound and a Natural Caloric Sweet-Tasting Carbohydrate

In this example, a mixture comprising 2% sucrose (2°Brix) and 30 ppm rebaudioside A (Reb A) was used as a base and compared to like mixtures that additionally comprised a rare sugar and to a mixture comprising 5% sucrose (5°Brix), which does neither comprise Reb A nor a rare sugar.

The rare sugar was added in a final amount of 2%. Different rare sugars were evaluated in this example, including allulose, rhamnose, trehalose, tagatose and arabinose.

The resulting mixtures were subjected to a sensory evaluation conducted by an expert panel. Two repetitions were made. The results are summarized in the following Tables 1 to 3 (results on arabinose are not shown).

TABLE 1
Results from two repetitions on the sweetness evaluation
of different mixtures by an expert panel (n = 10).

| | Onset | Overall | Full | Lingering | | |
|---|---|---|---|---|---|---|
| Composition | intensity | intensity | body | artificial | Off-notes | Remarks |
| 2° Brix + | 3.09 | 3.83 | 3.21 | 2.38 | 1.26 | |
| 30 ppm | | | | | | |
| Reb A | | | | | | |
| 5° Brix | 5.59 | 5.87 | 5.76 | 1.39 | 0.8 | |
| 2° Brix + | 4.27 | 4.69 | 4.3 | 2.21 | 1.26 | |
| 30 ppm Reb | | | | | | |
| A + 2% | | | | | | |
| allulose | | | | | | |
| 2° Brix + | 4.62 | 5.16 | 4.63 | 2.72 | 1.27 | |
| 30 ppm Reb | | | | | | |
| A + 2% | | | | | | |
| rhamnose | | | | | | |
| 2° Brix + | 3.99 | 4.49 | 3.92 | 2.5 | 1.25 | |
| 30 ppm Reb | | | | | | |
| A + 2% | | | | | | |
| trehalose | | | | | | |

TABLE 2
Results from two repetitions on the sweetness evaluation of different
mixtures by an expert panel (n = 9-10).

| | Onset | Overall | Full | Lingering | | |
|---|---|---|---|---|---|---|
| Composition | intensity | intensity | body | artificial | Off-notes | Remarks |
| 2° Brix + | 2.94 | 3.89 | 2.9 | 2.42 | 0.97 | Cloggy |
| 30 ppm | | | | | | |
| Reb A | | | | | | |
| 5° Brix | 4.77 | 5.5 | 4.76 | 1.37 | 1.3 | Fungal, |
| | | | | | | caramel |
| 2° Brix + | 3.41 | 4.05 | 3.49 | 2.07 | 1.08 | Bitter |
| 30 ppm Reb | | | | | | |
| A + 2% | | | | | | |
| allulose | | | | | | |
| 2° Brix + | 3.81 | 4.54 | 3.96 | 1.76 | 0.97 | Slightly |
| 30 ppm Reb | | | | | | bitter, |
| A + 2% | | | | | | cloggy |
| rhamnose | | | | | | |
| 2° Brix + | 4.6 | 5.66 | 4.73 | 1.67 | 0.8 | |
| 30 ppm Reb | | | | | | |
| A + 2% | | | | | | |
| tagatose | | | | | | |

TABLE 3
Tukey (HSD) analysis of differences between
categories with a 95% confidence interval.

| | Onset | Overall | Full | Lingering | | |
|---|---|---|---|---|---|---|
| Composition | intensity | intensity | body | artificial | Off-notes | Remarks |
| 2° Brix + | B | B | C | A | A | |
| 30 ppm Reb A | | | | | | |
| 5° Brix | A | A | A | A | A | |
| 2° Brix + | B | B | BC | A | A | |
| 30 ppm Reb A + | | | | | | |
| 2% allulose | | | | | | |
| 2° Brix + | AB | AB | AB | A | A | |
| 30 ppm Reb A + | | | | | | |
| 2% rhamnose | | | | | | |
| 2° Brix + | A | A | A | A | A | |
| 30 ppm Reb A + | | | | | | |
| 2% tagatose | | | | | | |

It was found that rhamnose is significantly more potent than allulose in sugar-reduced applications. In stevioside-sweetened applications, rhamnose and tagatose are found to be superior to allulose.

### Example 2: Sweetness-Enhancing Effect Imparted by a Taste Modifying Compound, Optionally in Combination with an Additional Natural Sweet Tasting Compound, in a Natural Caloric Sweet-Tasting Carbohydrate-Free Mixture of the Present Invention

In this example, a sweetening solution comprising 100 ppm Reb A (as natural sweet tasting compound) and 1% rhamnose (as rare sugar) was used as a base and compared to like solutions that additionally comprised one or more taste modifying compound(s) and, optionally, at least one additional natural sweet tasting compound. As the taste modifying compound(s), hesperetin dihydrochalkon (HC), hespertin (HT) and/or phloretin (PH) was/were used. As additional natural sweet tasting compound, a steviol glycoside (SG), glycosylated rubusoside (OR) or Lo Han Guo (LHG) was used.

The results of the sensory evaluation are summarized in Table 4 below. Effects that were found to be particularly strong are highlighted in the table by values marked in bold.

TABLE 4
Results on the sweetness evaluation of different mixtures.

| Components | | | | | | |
|---|---|---|---|---|---|---|
| in addition to | Onset | Overall | Full | Lingering | Off- | |
| the base¹ | intensity | intensity | body | artificial | notes | Remarks |
| — | 3.24 | 2.92 | 3.14 | 3.58 | 2.29 | Bitter, carrot |
| | | | | | | like taste |
| 5 ppm HC | 4.08 | 4.97 | 3.65 | 5.13 | 2.68 | Cloggy, |
| | | | | | | phenolic |
| 10 ppm HT + | 5.01 | 5.81 | 4.01 | 5.46 | 3.07 | Plastic, |
| 20 ppm PH + | | | | | | herbaceous |
| 9 ppm LHG | | | | | | off-note |
| 7 ppm HT + | 4.85 | 5.20 | 3.75 | 4.34 | 2.24 | Balsamic, |
| 56 ppm SG | | | | | | bitter |
| 20 ppm PH + | 4.87 | 5.63 | 3.80 | 5.02 | 2.36 | Bitter |
| 45 ppm OR | | | | | | |

¹base = 100 ppm Reb A + 1% rhamnose.

It was found that the sweet intensity (overall and impact) is strongly increased with all taste modifying compounds. Simultaneously, an undesired lingerie effect is increased.

### Example 3: Sweetness-Enhancing Effect Imparted by a Taste Modifying Compound, Optionally in Combination with an Additional Natural Sweet Tasting Compound, in a Natural Caloric Sweet-Tasting Carbohydrate Containing Mixture of the Present Invention

In this example, a sweetening solution comprising 2% sucrose (as natural caloric sweet-tasting carbohydrate), 60 ppm Reb A (as natural sweet tasting compound) and 1% rhamnose (as rare sugar) was prepared as a base and compared to like solutions that additionally comprised one or more taste modifying compound(s) and, optionally, at least one additional natural sweet tasting compound. The taste modifying compound(s) and additional natural sweet tasting compound were the same as in Example 2.

The results of the sensory evaluation are summarized in Table 5 below. Effects that were found to be particularly strong are highlighted in the table by values marked in bold.

TABLE 5
Results on the sweetness evaluation of different mixtures.

| Components | | | | | | |
|---|---|---|---|---|---|---|
| in addition to | Onset | Overall | Full | Lingering | Off- | |
| base² | intensity | intensity | body | artificial | notes | Remarks |
| — | 3.89 | 4.38 | 3.72 | 2.55 | 1.39 | |
| 5 ppm HC | 5.43 | 6.01 | 4.65 | 3.82 | 1.96 | Phenolic, |
| | | | | | | balsamic |
| 10 ppm HT + | 6.07 | 6.84 | 4.36 | 4.94 | 2.79 | Phenolic, |
| 20 ppm PH + | | | | | | balsamic, |
| 9 ppm LHG | | | | | | bitter |
| 56 ppm SG + | 4.72 | 5.68 | 4.14 | 3.55 | 2.16 | Alcoholic |
| 7 ppm HT | | | | | | side note, |
| | | | | | | bitter, slight |
| | | | | | | vanilla note |
| 20 ppm PH + | 5.06 | 5.97 | 4.39 | 3.50 | 2.09 | Honey like, |
| 45 ppm OR | | | | | | herbaceous |
| | | | | | | off-note, |
| | | | | | | tea note |

²base = 2% sucrose + 60 ppm Reb A + 1% rhamnose.

It was again found that the sweet intensity (overall and impact) is strongly increased with all taste modifying compounds and that, simultaneously, an undesired lingerie effect is increased. When comparing to the results shown in Table 4, it can be concluded that presence of a natural caloric sweet-tasting carbohydrate (here: sucrose) had a beneficial effect on the complete sweetness profile including an emphasis of the desired effects and a suppression of the undesired effects.

### Example 4: Sweetness-Enhancing Effect Imparted by a Rare Sugar in a Natural Caloric Sweet-Tasting Carbohydrate Free Mixture of the Present Invention

In this example, a sweetening solution comprising 100 ppm Reb A (as natural sweet tasting compound), 56 ppm SG (as additional natural sweet tasting compound) and 7 ppm HT (as taste modifying compound) was used as a base sweetening solution and compared to like solutions that additionally comprised a rare sugar in an amount of 1%. The tested rare sugars included rhamnose, allulose, trehalose, tagatose and arabinose.

The results of the sensory evaluation are summarized in Table 6 below. Effects that were found to be particularly strong are highlighted in the table by values marked in bold.

TABLE 6
Results on the sweetness evaluation of different mixtures.

| Components | | | | | | |
|---|---|---|---|---|---|---|
| in addition | Onset | Overall | Full | Lingering | Off- | |
| to base³ | intensity | intensity | body | artificial | notes | Remarks |
| — | 3.41 | 4.18 | 3.27 | 3.54 | 1.92 | Balsamic note |
| 1% rhamnose | 4.03 | 4.73 | 3.91 | 3.85 | 2.17 | Vanilla like, |
| | | | | | | peppery notes, |
| | | | | | | woody notes |
| 1% allulose | 4.28 | 5.06 | 3.51 | 4.42 | 2.76 | Phenolic, |
| | | | | | | peppery notes, |
| | | | | | | woody notes, |
| | | | | | | balsamic notes |
| 1% trehalose | 4.16 | 5.01 | 3.48 | 4.32 | 2.19 | Vanilla like, |
| | | | | | | balsamic notes |
| 1% tagatose | 4.16 | 4.82 | 4.01 | 3.38 | 2.39 | Balsamic |
| | | | | | | notes, |
| | | | | | | smoky notes, |
| | | | | | | stronger |
| | | | | | | phenolic |
| | | | | | | off notes |
| 1% arabinose | 3.82 | 4.22 | 3.99 | 2.98 | 2.09 | Slightly |
| | | | | | | herbaceous |

³base = 100 ppm Reb A + 56 ppm SG + 7 ppm HT.

Among the tested combinations, those containing rhamnose or trehalose performed best in regard of impact and intensity.

### Example 5: Sweetness-Enhancing Effect Imparted by a Rare Sugar in a Natural Caloric Sweet-Tasting Carbohydrate Free Mixture of the Present Invention

In this example, a mixture comprising 2% sucrose (as natural caloric sweet-tasting carbohydrate), 60 ppm Reb A (as natural sweet tasting compound), 20 ppm PH (as a taste modifying compound) and 45 ppm OR (as additional natural sweet tasting compound) was used as a base and compared to like mixtures that additionally comprised a rare sugar in an amount of 1%. The tested rare sugars included rhamnose, allulose, trehalose, tagatose and arabinose.

The results of the sensory evaluation are summarized in Table 7 below. Effects that were found to be particularly strong are highlighted in the table by values marked in bold.

TABLE 7
Results on the sweetness evaluation of different mixtures.

| Components | | | | | | |
|---|---|---|---|---|---|---|
| in addition to | Onset | Overall | Full | Lingering | Off- | |
| base⁴ | intensity | intensity | body | artificial | notes | Remarks |
| — | 4.07 | 5.02 | 4.11 | 3.38 | 2.21 | Woody, |
| | | | | | | peppery note |
| 1% rhamnose | 4.89 | 5.63 | 4.71 | 3.32 | 2.36 | Rum like note |
| 1% allulose | 4.67 | 5.42 | 4.68 | 3.19 | 2.30 | Rum like note |
| 1% trehalose | 4.54 | 5.45 | 4.74 | 3.63 | 2.29 | Rum like note |
| 1% tagatose | 4.78 | 5.55 | 4.81 | 3.18 | 2.16 | Appley, |
| | | | | | | slightly |
| | | | | | | fermented |
| 1% arabinose | 4.58 | 5.33 | 4.51 | 2.99 | 2.13 | |

⁴base = 60 ppm Reb A + 20 ppm PH + 45 ppm OR.

As can be gathered from Table 7, a mixture comprising a rare sugar, a taste modifying compound and at least one natural sweet tasting compound turned out to have a superior property profile as compared to a like mixture that does not contain a rare sugar. All desired effects were remarkably increased for all tested rare sugars, whereas the presence of rhamnose, allulose, tagatose and arabinose lead to a strong decrease of the lingering artificial sweetness. The addition of rhamnose or tagatose to the base was found to lead to a particular improvement of the impact sweetness and the mouth feeling (full body).

### Example 6: Further Evaluation of the Sweetness-Enhancing Effect Imparted by Tagatose in a Natural Caloric Sweet-Tasting Carbohydrate Containing Mixture of the Present Invention

In this example, a mixture comprising 2% sucrose (as natural caloric sweet-tasting carbohydrate) and 60 ppm Reb A (as natural sweet tasting compound) was used as a base and compared to like mixtures that additionally comprised PH (as taste modifying compound) in combination with OR (as additional natural sweet tasting compound) and/or tagatose (as rare sugar) in an amount of 1%.

The results of the sensory evaluation are summarized in Table 8 below. Effects that were found to be particularly strong are highlighted in the table by values marked in bold.

TABLE 8
Results on the sweetness evaluation of different mixtures.

| Components | | | | | | |
|---|---|---|---|---|---|---|
| in addition to | Onset | Overall | Full | Lingering | Off- | |
| base⁵ | intensity | intensity | body | artificial | notes | Remarks |
| — | 3.55 | 4.20 | 3.69 | 2.70 | 1.85 | |
| 20 ppm PH + | 4.80 | 5.57 | 4.18 | 3.72 | 2.36 | |
| 45 ppm OR | | | | | | |
| 1% Tagatose | 4.47 | 4.71 | 4.13 | 2.51 | 1.97 | Woody, |
| | | | | | | peppery |
| 20 ppm PH + | 5.35 | 5.69 | 4.89 | 3.15 | 2.55 | Fruity, tea, |
| 45 ppm OR + | | | | | | slightly |
| 1% Tagatose | | | | | | dairy note |

⁵base = 2% sucrose + 60 ppm Reb A.

It was surprisingly found that a combination comprising a rare sugar, a taste modifying compound, at least one natural sweet tasting compound, and a natural caloric sweet-tasting carbohydrate was superior over like combinations that already performed superior but either lacked a rare sugar or a taste modifying compound. These results demonstrate that a mixture comprising a rare sugar, a taste modifying compound, at least one natural sweet tasting compound, and a natural caloric sweet-tasting carbohydrate is associated with beneficial effects including a remarkably increased onset sweetness intensity, overall sweetness intensity and full body. The beneficial effect was particularly pronounced with respect to the full body effect.

Moreover, when comparing the results from Tables 7 and 8 it can be concluded that replacing a natural caloric sweet-tasting carbohydrate (here: sucrose) in a mixture further comprising a taste modifying compound and at least one natural sweet tasting compound by a rare sugar leads to a remarkably improved property profile, where desired effects are increased and undesired effects are suppressed. Even more surprising is the observation that the increased lingering artificial sweetness from 3.38 to 3.72 associated with sucrose (cf. Table 7) could be completely neutralized and even lowered to 3.15 by the addition of tagatose (cf. Table 8). These results clearly demonstrate the superior sweetness taste profile associated with the mixture of the present invention.

### Example 7: Ice Tea Containing a Natural Caloric Sweet-Tasting Carbohydrate Containing Mixture of the Invention

In this example, different ice tea preparations were prepared. The ingredients were mixed in the order listed in Table 9 into bottles and then sterilized.

TABLE 9
Ice tea preparations.

| | Preparations (amounts in wt.-% or ppm if specified accordingly) | | | | | | | | |
|---|---|---|---|---|---|---|---|---|---|
| Ingredients | A | B | C | D | E | F | G | H | |
| sucrose | 7 | 3.5 | 3.5 | 3.5 | 3.5 | 3.5 | 1.5 | — | |
| allulose | — | — | 1 | — | — | 0.5 | 2 | 7 | |
| rhamnose | | 1 | 2 | — | — | — | — | — | |
| allose | | 3 | — | 3 | — | — | — | — | |
| trehalose | | — | — | — | 3 | — | — | — | |
| tagatose | | — | — | — | — | 2 | — | — | |
| arabinose | | — | — | — | — | — | 3 | — | |
| Hesperetin (HT) | — | — | 5 ppm | — | — | — | — | 7 | ppm |
| Phloretin (PH) | — | — | — | 15 ppm | — | — | — | 15 | pmm |

| | | | | | | | | |
|---|---|---|---|---|---|---|---|---|
| Hersperetin | — | — | — | — | 15 ppm | — | 5 ppm | — |
| dihydrochalcone | | | | | | | | |
| (HC) | | | | | | | | |
| Alpha- | — | — | — | — | — | 5 ppm | 10 ppm | — |
| glycosylated | | | | | | | | |
| rubusosides | | | | | | | | |
| (OR) | | | | | | | | |
| Alpha- | — | 10 | 10 | — | 10 | — | — | — |
| glycosylated | | | | | | | | |
| steviosides (SG) | | | | | | | | |
| Rebaudioside A | — | — | — | 10 | — | — | — | — |
| Rebaudioside M | — | — | — | — | 10 | 10 | — | — |
| Citric acid | 0.15 | 0.15 | 0.15 | 0.15 | 0.15 | 0.15 | 0.15 | 0.15 |
| ascorbic acid | 0.02 | 0.02 | 0.02 | 0.02 | 0.02 | 0.02 | 0.02 | 0.02 |
| Black tea extrakt | 0.15 | 0.15 | 0.15 | 0.15 | 0.15 | 0.15 | 0.15 | 0.15 |
| natural lemon | 0.1 | 0.1 | 0.1 | 0.1 | 0.1 | 0.1 | 0.1 | 0.1 |
| flavor | | | | | | | | |

| | |
|---|---|
| Water | to 100% |

A and H: Comparative preparations.
B-G: preparations in accordance to the invention.

### Example 8: Carbonated Soft Drink (Flavor Direction: Cola) Containing a Mixture of the Invention

In this example, carbonated soft drinks are prepared. The solid components or ingredients shown in Table 10 are individually mixed with water, combined and made up to 100 g with water. The concentrate obtained is then allowed to age over night at ambient temperature. Finally, 1 part concentrate is mixed with 5 parts carbonated water, filled into bottles and sealed.

TABLE 10
Carbonated soft drinks.

| Ingredient (% by weight) | A | B | C | D | E | F | G | H | I | J |
|---|---|---|---|---|---|---|---|---|---|---|
| Phosphoric acid 85% | 0.635 | 0.635 | 0.635 | 0.635 | 0.700 | 0.5 | 0.5 | 0.5 | 0.5 | 0.5 |
| Citric acid, anhydrous | 0.064 | 0.064 | 0.064 | 0.064 | — | 0.25 | 0.25 | 0.25 | 0.25 | 0.25 |
| Caffeine | 0.064 | 0.064 | 0.070 | 0.064 | 0.060 | 0.064 | 0.064 | 0.064 | 0.064 | 0.03 |
| Sucrose | 63.60 | — | — | — | 12.9 | 15.1 | 0 | 0 | 0 | 0 |
| Rebaudioside M | — | 0.200 | — | — | — | 0.100 | 0.200 | — | — | — |
| Glycosylated steviosides | — | — | 0.150 | — | — | — | — | 0.150 | — | — |
| Aspartame | — | — | — | — | 0.07 | — | — | — | — | 0.07 |
| Rebaudioside A | — | — | — | 0.150 | — | — | — | — | 0.150 | — |
| Acesulfame K | — | — | — | — | 0.07 | — | — | — | — | 0.07 |
| Mogroside V | — | — | — | 0.150 | — | — | — | — | 0.150 | — |
| Sugar colouring | 0.00 | 0.700 | 0.650 | 0.800 | 0.800 | 0.700 | 0.800 | 0.800 | 0.800 | 0.800 |
| Cola type drink emulsion | 1.545 | 1.445 | 1.445 | 1.445 | 1.445 | 1.300 | 1.445 | 1.2 | 1.6 | 1.3 |
| Sodium benzoate | 0.106 | 0.106 | 0.106 | 0.106 | 0.106 | — | — | — | — | — |
| D-Allulose | 10 | — | 2 | — | — | 5 | — | 1 | — | — |
| rhamnose | — | 6 | — | 2 | 2 | — | 3 | — | 1 | 1 |
| allose | — | 2 | 2 | — | — | — | 1 | 1 | — | — |
| trehalose | — | — | 2 | 4 | 3 | — | — | 1 | 2 | 3 |
| Tagatose | — | — | 2 | 2 | 3 | — | — | 1 | 1 | 3 |
| arabinose | — | — | — | 4 | — | — | — | — | 2 | — |
| D-Xylulose | — | — | — | — | — | 5 | 3 | — | — | — |
| D-Xylitol | — | — | — | — | — | — | 2 | — | — | — |
| Erythritol | — | — | — | — | — | — | — | 4 | 3 | — |
| Mannitol | — | — | — | — | — | — | — | — | 3 | — |
| Galactitol | — | — | — | — | — | — | — | — | — | 1 |
| Alpha- | — | — | — | — | 0.001 | 0.001 | — | — | — | 0.001 |
| GlucosylatedRubusosides | | | | | | | | | | |
| (OR) | | | | | | | | | | |
| Hesperetin, racemic, 2.5% | — | 2.0 | 2.0 | — | — | — | 2.0 | 2.0 | — | — |
| in 1,2-propylene glycol | | | | | | | | | | |
| Phloretin, 2.5% in | — | — | 1.0 | — | — | 1.0 | — | 1.0 | — | — |
| 1,2-propylene glycol | | | | | | | | | | |
| Phyllodulcin, 0.5% in | — | — | — | 1.0 | — | — | — | — | 1.0 | — |
| 1,2-propylene glycol | | | | | | | | | | |
| Hesperetin | — | — | — | — | 1.0 | — | — | — | — | 1.0 |
| dihydrochalcone (I) 0.5% | | | | | | | | | | |
| in 1,2-propylene glycol | | | | | | | | | | |

| | |
|---|---|
| Water | ad 100 |

A: drink containing sugar (comparative drink).
B-E: low-calorie drinks (in accordance to the invention)

### Example 9: Sugar-Reduced Tomato Ketchup Containing a Natural Caloric Sweet-Tasting Carbohydrate Containing Mixture of the Invention

In this example, sugar-reduced tomato ketchup preparations are prepared. The Flavoring Part is mixed first and added to the other ingredients which are mixed in the stated sequence and the finished ketchup is homogenized using an agitator, poured into bottles and sterilized.

TABLE 11
Sugar-reduced tomato ketchup preparations.

| | Preparation (amounts in weight-%) | | | | | | | |
|---|---|---|---|---|---|---|---|---|
| Ingredients | A | B | C | D | E | F | G | H |
| Common salt | 2.0 | 2.0 | 2.0 | 2.0 | 2.0 | 2.0 | 2.0 | 2.0 |
| Starch, Farinex WM 55 | 1.0 | 1.0 | 1.0 | 1.0 | 1.0. | 1.0 | 1.0 | 1.0 |
| Sucrose | 12.0 | 5 | 6 | 7 | 4 | 7 | 5 | — |
| Tomato concentrate ×2 | 40.0 | 40.0 | 40.0 | 40.0 | 30.0 | 30.0 | 30.0 | 30.0 |
| Glucose syrup 80 Brix | 18.0 | 18.0 | 18.0 | 18.0 | 18.0 | 18.0 | 18.0 | 18.0 |
| Spirit vinegar 10% | 7.0 | 7.0 | 7.0 | 7.0 | 3.0 | 3.0 | 3.0 | 3.0 |

Flavoring Part:

| | | | | | | | | |
|---|---|---|---|---|---|---|---|---|
| spice flavour | 0.1 | 0.1 | 0.1 | 0.1 | 0.1 | 0.1 | 0.1 | 0.1 |
| D-Allulose | | 3 | | | | | | 5 |
| Rhamnose | — | — | 3 | — | — | — | — | — |
| Allose | — | — | — | 4 | — | — | — | — |
| Trehalose | — | — | — | — | 5 | — | — | 2 |
| Tagatose | — | — | — | — | — | 3 | — | 5 |
| Arabinose | — | — | — | — | — | — | 6 | — |
| Alpha-glycosylated | — | — | — | 20 ppm | 20 ppm | — | — | — |
| rubusosides (OR) | | | | | | | | |
| Rebaudioside A | — | — | 100 ppm | — | — | — | — | — |
| Rebaudiosid M | — | 100 ppm | — | — | 100 ppm | — | — | — |
| Hesperetin 2.5% in | — | — | 0.1 | 0.1 | — | 0.1 | — | 0.1 |
| 1,2-Propylene glycol | | | | | | | | |
| Phloretin 2.5% in | — | — | 0.1 | 0.1 | — | 0.1 | — | 0.1 |
| 1,2-Propylene glycol | | | | | | | | |
| Alpha-Glycosylated | — | — | — | 0.1 | 0.1 | 0.05 | — | — |
| rubusoside | | | | | | | | |
| Hesperetin | — | — | — | — | — | — | 0.2 | — |
| dihydrochalcone 0.5% | | | | | | | | |
| in 1,2-Propylene glycol | | | | | | | | |
| Phyllodulcin, 0.5% in | — | — | — | — | 0.2 | 0.1 | — | 0.2 |
| ethanol/1,2-propylene | | | | | | | | |
| glycol | | | | | | | | |

| | |
|---|---|
| Water | ad 100 |

A: Comparative preparation with sugar.
B-F: Preparations in accordance with the invention.

### Example 10: Instant Ice Tea Type Peach

In this example, instant ice tea preparations are prepared by mixing the ingredients listed in Table 12 together. The standard dosage in water for preparing a peach ice tea beverage based on the instant is 7.5% by weight.

TABLE 12
Instant Ice Tea Type Peach preparations.
A-C: Comparative preparations.
D: preparation according to the present invention.

| | Preparations (amounts in weight-%) | | | |
|---|---|---|---|---|
| Ingredients | A | B | C | D |
| Sucrose, extra fine | 95.06 | 70.09 | 70.25 | — |
| Citric acid, anhydrous | 2.2 | 2.0 | 2.0 | 1.8 |
| Black Tea extract, | 1.34 | 1.34 | 1.34 | 1.34 |
| powdered | | | | |
| Peach aroma spray dried | 0.66 | 0.66 | 0.66 | 0.66 |
| Tea aroma type | 0.27 | 0.27 | 0.27 | 0.27 |
| Ceylon dried | | | | |
| Trisodium citrate | 0.25 | 0.25 | 0.25 | 0.25 |
| Ascorbic acid | 0.22 | 0.22 | 0.22 | 0.22 |
| Polydextrose | — | — | — | 25 |
| D-Allulose, crystalline | — | 10 | — | 30 |
| Trehalose | — | 10 | 25 | — |
| Rhamnose | — | — | — | 30 |
| Tagatose | — | 5 | — | 10 |
| Hesperetin | — | — | 0.01 | 0.01 |
| dihydrochalcone (I) | | | | |
| Hesperetin | — | 0.05 | — | — |
| Rebaudioside A | — | — | 0.01 | 0.01 |
| Phloretin | — | 0.02 | — | — |
| Rebaudioside M | — | 0.1 | — | 0.20 |
| Homoeriodictyol- | — | 0.1 | — | 0.05 |
| Sodium salt | | | | |

### Example 11: Chocolate Drink Instant Powder

TABLE 13
instant powder preparations for a chocolate drink.
A-C: Comparative preparations.
D: preparation according to the present invention.

| Ingredient | Use in weight % | | | |
|---|---|---|---|---|
| Preparation | A | B | C | D |
| Sucrose, extra fine | 73.5 | 48.475 | 43.69 | 13.325 |
| Cocoapowder | 25.0 | 25.0 | 25.0 | 25.0 |
| alkalized, 10-12% | | | | |
| by weight fat | | | | |
| Maltodextrin DE15- | 0.43 | 0.43 | 0.43 | 0.43 |
| 19 from corn starch | | | | |
| Salt (NaCl), extra | 0.43 | 0.43 | 0.43 | 0.43 |
| fine | | | | |
| Ascorbic acid | 0.29 | 0.29 | 0.29 | 0.29 |
| Vitamin mix M8 | 0.145 | 0.145 | 0.145 | 0.145 |
| 40-1507 | | | | |
| D-Allulose, | — | 10 | — | 30 |
| crystalline | | | | |
| Trehalose | — | 10 | 30 | — |
| Rhamnose | — | — | — | 30 |
| Tagatose | — | 5 | — | 10 |
| Hesperetin | — | — | 0.015 | 0.01 |
| dihydrochalcone (I) | | | | |
| Hesperetin | — | 0.05 | — | — |
| Rebaudioside A | — | — | 0.01 | 0.02 |
| Phloretin | — | 0.03 | — | — |
| Rebaudioside M | — | — | — | 0.30 |
| Homoeriodictyol- | — | 0.15 | — | 0.05 |
| Sodium salt | | | | |

### Example 12: Sucrose Reduced Yogurt (−50% Added Sucrose)

Part I: Yoghurt

TABLE 14

| Ingredient | Use in weight % | | | | | | | | | |
|---|---|---|---|---|---|---|---|---|---|---|
| Preparation | A | B | C | D | E | F | G | H | I | J |
| Sucrose, extra fine | 11.20 | 5.60 | 5.60 | 5.60 | 4.10 | 5.60 | 5.60 | 5.60 | 5.60 | |
| Standard Yogurt Culture | 0.004 | 0.004 | 0.004 | 0.004 | 0.004 | 0.004 | 0.004 | 0.004 | 0.004 | 0.004 |
| Natural Strawberry Flavor | 0.1 | 0.1 | 0.1 | 0.1 | 0.1 | 0.1 | 0.1 | 0.1 | 0.1 | 0.1 |
| D-Allulose, crystalline | | 3.15 | | | | 0.5 | 1.0 | | | 2.0 |
| D-Galactose | | | 2.5 | | | 2.0 | | | 2.0 | |
| D-Tagatose | | | | 3.05 | | | 2.05 | 3.05 | 0.5 | 1.05 |
| Hesperetin, 1% Lösung in | | | 0.1 | | — | 0.03 | | 0.1 | 0.05 | 0.1 |
| 1,2-Propylenglycol | | | | | | | | | | |
| Phloretin, 1% Lösung in | | 0.1 | 0.03 | 0.1 | | 0.03 | 0.06 | | 0.05 | 0.05 |
| 1,2-Propylenglycol | | | | | | | | | | |
| Steviol Glycoside 95% | — | | | | 1.05 | | | | | |
| alpha-glucosylated steviol glycosides | — | | | | | 0.013 | 0.13 | | 0.0325 | 0.0325 |

| | |
|---|---|
| pasteurized Milk, 3.5% | ad to 100 |

A: Comparative full sugar preparation.
E: Comparative reduced sugar preparation with steviolgylcosides as sweetener.
B-D, F-J: preparation according to the present invention.

The ingredients are mixed and fermented at 22-30° C. for 6-12 h. The product is stored at 4-8° C. before consummation.

Part II: Fruit Preparation for Yogurt with No Added Sucrose

TABLE 15

| Ingredient | A | B | C | D | E |
|---|---|---|---|---|---|
| Water | 21.82% | 21.85% | 21.75% | 21.75% | 21.75% |
| Fruit Residue Puree e.g. from | | 27.00% | | | |
| Strawberry, Apple, Banana | | | | | |
| Pectin | 0.25% | 0.15% | 0.25% | 0.25% | 0.25% |
| Sucrose | 27.00% | 0.00% | | | |
| Guar Gum | 0.15% | 0.15% | 0.15% | 0.15% | 0.15% |
| Potassium Sorbate | 0.13% | 0.13% | 0.13% | 0.13% | 0.13% |
| Frozen Fruit e.g. Strawberry | 50.00% | 50.00% | 50.00% | 50.00% | 50.00% |
| Natural Strawberry Flavor | 0.65% | 0.65% | 0.65% | 0.65% | 0.65% |
| D-Allulose | | | | 27.00% | 5.00% |
| D-Galactose | | | | | 22.00% |
| D-Tagatose | | | 27.00% | | |
| alpha-glucosylated rubusoside | | 0.07% | 0.07% | 0.07% | 0.07% |

Blend 20% Fruit Preparation Part II with 80% Yogurt Part I, fill and store at 5-8° C.

1. A mixture comprising components a), b) and c), and optionally, component d), wherein
component a) is at least one rare sugar,
component b) is at least one taste modifying compound chosen from hydroxyflavonoids, dihydrochalcons, dihydroisocoumarins, hydroxylignans, and mixtures thereof,
component c) is at least one natural sweet tasting compound, and
component d), if present, is at least one natural caloric sweet-tasting carbohydrate and/or at least one non-caloric sweet tasting sugar alcohol.

2. The mixture according to claim 1, wherein component b) comprises hesperetin, hesperetin dihydrochalcone, naringenin, phloretin, eriodictyol, homoeriodictyol, or mixtures thereof.

3. The mixture according to claim 1, wherein component b) comprises
hesperetin or hesperetin dihydrochalcone or phloretin or phyllodulcin, or
hesperetin and hesperetin dihydrochalcone, or
hesperetin and phloretin, or
hesperetin and phyllodulcin, or
hesperetin dihydrochalcone and phloretin, or
hesperetin dihydrochalcone and phyllodulcin, or
phloretin and phyllodulcin,
hesperetin and hesperetin dihydrochalcone and phloretin, or
hesperetin and hesperetin dihydrochalcone and phyllodulcin, or
hesperetin and phloretin and phyllodulcin, or
hesperetin dihydrochalcone and phloretin and phyllodulcin, or
hesperetin and hesperetin dihydrochalcone and phloretin and phyllodulcin.

4. The mixture according to claim 1, wherein component c) comprises at least one steviol glycoside.

5. The mixture according to claim 1, wherein component d) comprises at least one sugar chosen from sucrose, fructose, glucose, galactose, lactose, dextrose, maltose, sorbitol, xylitol, isomalt, lactitol, maltitsorbitol, erythritol, mannitol, galactitol, and mixtures thereof, preferably sucrose, D-fructose, D-glucose, D-galactose, D-lactose, D-maltose, sorbitol, xylitol, isomalt, lactitol, maltitsorbitol, erythritol, mannitol, galactitol, and mixtures thereof.

6. The mixture according to claim 1, wherein:
the weight ratio of component a) to component b) ranges from 100,000:1 to 10:1, and/or
the weight ratio of component a) to component c) ranges from 20,000:1 to 2:1, and/or
the weight ratio of component a) to component d), if present, ranges from 10:1 to 1:200, and/or
the weight ratio of component b) to component c) ranges from 100:1 to 1:100.

7. The mixture according to claim 1, further comprising component e), wherein component e) is at least one substance chosen from flavorings and/or aromatic substances other than compounds falling within one of the definitions of components a) to d).

8. A flavoring composition, concentrate, and/or intermediate for a food or beverage product comprising the mixture of claim 1.

9. A food or beverage product comprising a flavoring composition, concentrate, and/or intermediate according to claim 8.

10. The food or beverage product according to claim 9, wherein the amount of the mixture ranges from 0.05 to 25% by weight, based on the total weight of the food or beverage product.

11. The food or beverage product according to claim 9, wherein
the amount of component a) ranges from 0.1 to 10% by weight, based on the total weight of the food or beverage product, and/or
the amount of component b) ranges from 1 to 100 ppm by weight, based on the total weight of the food or beverage product, and/or
the amount of component c) ranges from 5 to 500 ppm by weight, based on the total weight of the food or beverage product, and/or
the amount of component d), if present, ranges from 1.0 to 30% by weight, based on the total weight of the food or beverage product.

12. The food or beverage product according to claim 9, wherein
component a) comprises L-arabinose, D-tagatose, D-allulose, D-allose, L-rhamnose, D-trehalose, or combinations thereof,
component b) comprises phloretin, hesperetin, or combinations thereof,
component c) comprises rebaudioside A, glycosylated rubusoside, glucosylated steviosides, luo han guo extract, or combinations thereof, and
component d), if present, comprises sucrose, glucose, fructose, lactose, or combinations thereof.

13. The food or beverage product according to claim 9, further comprising component f), wherein component f) is at least one artificial sweet tasting compound.

14. A method for imparting a sweet taste impression and/or reinforcing a sweet taste impression of a flavoring composition, a concentrate, and/or an intermediate for a food or beverage product comprising incorporating a mixture of claim 1 into the flavoring composition, concentrate, and/or intermediate.

15. A method for enhancing the onset of sweetness intensity, overall sweetness intensity, and/or full body of a flavoring composition, a concentrate, and/or an intermediate for a food or beverage product comprising incorporating a mixture of claim 1 into the flavoring composition, concentrate, and/or intermediate.

16. The mixture of claim 1, wherein the at least one rare sugar of component a) is chosen from D-(+)-allulose, L-(+)-rhamnose, L-fucose, L-(+)-arabinose, D-(−)-tagatose, D-(+)-trehalose, D-(+)-xylose, D-(+)-allose, D-(+)-altrose, D-(−)-gulose, D-(+)-mannose, D-(−)-idose, D-(+)-talose, D-(−)-lyxose, (D)-xylulose, (D)-ribulose, D-(−)-erythrose, D-(−)-threose, D-(+)-melezitiose, D-(+)-raffinose and mixtures thereof, preferably D-(+)-allulose, L-(+)-rhamnose, L-(+)-arabinose, D-(−)-tagatose, D-(+)-trehalose, D-(+)-allose and mixtures thereof.

17. The mixture of claim 1, wherein the at least one natural sweet tasting compound of component c) is chosen from steviol glycoside, steviolmonoside, steviolbioside A, steviolbioside B, stevioside B, stevioside C, rebaudioside A, rebaudioside AM, rebaudioside B, rebaudioside C (dulcoside B), rebaudioside D, rebaudioside E, rebaudioside E2, rebaudioside E3, rebaudioside F, rebaudioside I, rebaudioside H, rebaudioside L, rebaudioside K, rebaudioside KA, rebaudioside J, rebaudioside N, rebaudioside O, rebaudioside M, rebaudioside X, dulcoside A, rubusoside, glycosylated rubusosides, suavososides, Rubus suavissumus leaf extract, Stevia leaf extract, stevioside, glycosylated steviol glycosides, glycosylated steviosides, mogroside V, isomogroside, mogroside IV, Luo Han Guo fruit extract, siamenoside, monatin and its salts (monatin SS, RR, RS, SR), curculin, glycyrrhizic acid and its salts, thaumatin, monellin, mabinlin, brazzein, hernandulcin, Lippia dulcis extract, glycyphyllin, Smilax glycyphylla extract, phloridzin, Malus derived extracts, trilobatin, Malus trilobata derived extraxts, baiyunoside, osladin, polypodoside A, pterocaryoside A, pterocaryoside B, mukurozioside, phlomisoside I, periandrin I, abrusoside A, cyclocarioside I, Balansin A, Balansin B, and combinations thereof.

18. The mixture of claim 4, wherein the at least one steviol glycoside is rebaudioside A, glucosylated steviosides, rubusoside, glycosylated rubusoside, Stevia leaf extract, Rubus suavissimus extract, mogrosides, luo han guo, or mixtures thereof.

19. The mixture according to claim 1 wherein:
the weight ratio of component a) to component b) ranges from 100,000:1 to 10:1,
the weight ratio of component a) to component c) ranges from 20,000:1 to 2:1,
the weight ratio of component a) to component d), if present, ranges from 10:1 to 1:200, and
the weight ratio of component b) to component c) ranges from 100:1 to 1:100.

20. The mixture according to claim 1, wherein:
the weight ratio of component a) to component b) ranges from 20,000:1 to 100:1,
the weight ratio of component a) to component c) ranges from 5,000:1 to 20:1,
the weight ratio of component a) to component d), if present, ranges from 10:1 to 1:20, and
the weight ratio of component b) to component c) ranges from 10:1 to 1:40.
